(19) United States
(12) Patent Application Publication
(10) Pub. No.: US 2021/0128384 A1
(43) Pub. Date: May 6, 2021

(54) MOVING BED ROBOT AND METHOD OF CONTROLLING THE SAME

(71) Applicant: LG Electronics Inc., Seoul (KR)

(72) Inventor: Sangwook LEE, Seoul (KR)

(73) Assignee: LG Electronics Inc., Seoul (KR)

(21) Appl. No.: 16/826,438

(22) Filed: Mar. 23, 2020

(30) Foreign Application Priority Data
Oct. 30, 2019 (KR) 10-2019-0136385

(51) Int. Cl. A61G 7/08; A61G 7/05

(52) U.S. Cl. CPC A61G 7/08; A61G 7/0528

(57) ABSTRACT

A moving bed robot including a plurality of load cells configured to detect external force applied to the moving bed robot in a horizontal direction, a driving wheel provided on a lower portion of the moving bed robot, a driving motor configured to rotate the driving wheel, at least one caster provided in a lower portion of the moving bed robot, and a controller configured to detect, via the plurality of load cells, first external force in a first direction and second external force in a second direction perpendicular to the first direction, set a movement mode of the moving bed robot based on a result of detection, and control driving of the driving motor based on the set movement mode is provided. A method of controlling a moving bed robot is also provided.

### CROSS-REFERENCE TO RELATED APPLICATIONS

The present application claims priority under 35 U.S.C. 119 to Korean Patent Application No. 10-2019-0136385, filed on Oct. 30, 2019, which is hereby incorporated by reference in its entirety.

### BACKGROUND

The present disclosure relates to a moving bed robot and a method of controlling a moving bed robot.

In general, a moving bed is used as a device for transporting a patient in need of surgery to an operating room, transporting a patient to a hospital room after surgery, or safely transporting an unconscious or emergency patient.

An assistant can move the moving bed by pulling the moving bed from in front, pushing the moving bed from behind, or pushing or pulling the moving bed from the side.

However, there is a problem in that the physical energy expelled by the assistant is large when repeatedly move the moving bed while bearing the weight of the patient. In addition, there is a problem that it is difficult to change the direction of the moving bed while bearing the weight of the patient.

### SUMMARY

An object of the present disclosure is to provide a moving bed robot capable of providing an optimal movement mode according to applied external force.

Another object of the present disclosure is to provide a moving bed robot which enables efficient power consumption of a driving motor.

A moving bed robot according to an embodiment includes a plurality of load cells configured to detect external force applied to the moving bed robot in a horizontal direction, a driving wheel provided on a lower portion of the moving bed robot, and a driving motor configured to rotate the driving wheel.

The moving bed robot may include a controller configured to set a movement mode of the moving bed robot based on a direction of external force detected via the plurality of load cells and control driving of the driving motor based on the set movement mode.

The controller may detect first external force in a front-and-rear direction and second external force in a left-and-right direction via the plurality of load cells and set a movement mode to an assist mode or a caster mode based on a difference between the detected first external force and second external force.

In the assist mode, the controller may control driving of the driving motor based on the external force detected via the plurality of load cells.

In the caster mode, the controller may deactivate driving of the driving motor.

In some embodiments, the controller may detect contact between the driving wheel and a floor surface and set the movement mode based on a result of detection.

A method of controlling a moving bed robot according to another embodiment includes detecting first external force applied to the moving bed robot in a first direction and second external force in a second direction perpendicular to the first direction, via a plurality of load cells for detecting external force in a horizontal direction, setting a movement mode of the moving bed robot based on a difference between the first external force and the second external force, and controlling a driving motor connected to a driving wheel of the moving bed robot based on the set movement mode.

### BRIEF DESCRIPTION OF THE DRAWINGS

FIG. 1 illustrates an AI device including a robot according to an embodiment of the present disclosure.

FIG. 2 illustrates an AI server connected to a robot according to an embodiment of the present disclosure.

FIG. 3 illustrates an AI system according to an embodiment of the present disclosure.

FIG. 4 is a perspective view of a moving bed robot according to an embodiment.

FIG. 5 is an exploded perspective view of the moving bed robot according to the embodiment.

FIG. 6 is a view illustrating the bottom surface of the upper plate according to an embodiment.

FIG. 7 is a cross-sectional view taken along line A-A′ of FIG. 4.

FIG. 8 is an enlarged view illustrating a driving wheel module and the surroundings thereof according to an embodiment.

FIG. 9 is a control block diagram of the moving bed robot according to an embodiment.

FIG. 10 is a flowchart illustrating movement mode switching operation of a moving bed robot.

FIGS. 11 to 12 are views illustrating examples of switching a movement mode of a moving bed robot to an assist mode.

FIGS. 13 to 14 are views illustrating examples of switching a movement mode of a moving bed robot to a caster mode.

FIG. 15 is a flowchart illustrating movement mode switching operation of a moving bed robot.

FIGS. 16 to 17 are views illustrating examples related to operation shown in FIG. 15.

### DETAILED DESCRIPTION OF THE EMBODIMENTS

Description will now be given in detail according to exemplary embodiments disclosed herein, with reference to the accompanying drawings. The accompanying drawings are used to help easily understand the embodiments disclosed in this specification and it should be understood that the embodiments presented herein are not limited by the accompanying drawings. As such, the present disclosure should be construed to extend to any alterations, equivalents and substitutes in addition to those which are particularly set out in the accompanying drawings.

A robot may refer to a machine that automatically processes or operates a given task by its own ability. In particular, a robot having a function of recognizing an environment and performing a self-determination operation may be referred to as an intelligent robot.

Robots may be classified into industrial robots, medical robots, home robots, military robots, and the like according to the use purpose or field.

The robot may include a driving unit having an actuator or a motor which may perform various physical operations such as moving a robot joint. In addition, a movable robot may include a wheel, a brake, a propeller, or the like in a driving unit, and may travel on the ground or fly in the air via the driving unit.

Artificial intelligence refers to the field of studying artificial intelligence or methodology for making artificial intelligence, and machine learning refers to the field of defining various issues dealt with in the field of artificial intelligence and studying methodology for solving the various issues. Machine learning is defined as an algorithm that enhances the performance of a certain task through a steady experience with the certain task.

An artificial neural network (ANN) is a model used in machine learning and may mean a whole model of problem-solving ability which is composed of artificial neurons (nodes) that form a network by synaptic connections. The artificial neural network can be defined by a connection pattern between neurons in different layers, a learning process for updating model parameters, and an activation function for generating an output value.

The artificial neural network may include an input layer, an output layer, and optionally one or more hidden layers. Each layer includes one or more neurons, and the artificial neural network may include a synapse that links neurons to neurons. In the artificial neural network, each neuron may output the function value of the activation function for input signals, weights, and deflections input through the synapse.

Model parameters refer to parameters determined through learning and include a weight value of synaptic connection and deflection of neurons. A hyperparameter means a parameter to be set in the machine learning algorithm before learning, and includes a learning rate, a repetition number, a mini batch size, and an initialization function.

The purpose of the learning of the artificial neural network may be to determine the model parameters that minimize a loss function. The loss function may be used as an index to determine optimal model parameters in the learning process of the artificial neural network.

Machine learning may be classified into supervised learning, unsupervised learning, and reinforcement learning according to a learning method.

The supervised learning may refer to a method of learning an artificial neural network in a state in which a label for learning data is given, and the label may mean the correct answer (or result value) that the artificial neural network must infer when the learning data is input to the artificial neural network. The unsupervised learning may refer to a method of learning an artificial neural network in a state in which a label for learning data is not given. The reinforcement learning may refer to a learning method in which an agent defined in a certain environment learns to select a behavior or a behavior sequence that maximizes cumulative compensation in each state.

Machine learning, which is implemented as a deep neural network (DNN) including a plurality of hidden layers among artificial neural networks, is also referred to as deep learning, and the deep learning is part of machine learning. In the following, machine learning is used to mean deep learning.

Self-driving refers to a technique of driving for oneself, and a self-driving vehicle refers to a vehicle that travels without an operation of a user or with a minimum operation of a user.

For example, the self-driving may include a technology for maintaining a lane while driving, a technology for automatically adjusting a speed, such as adaptive cruise control, a technique for automatically traveling along a predetermined route, and a technology for automatically setting and traveling a route when a destination is set.

The vehicle may include a vehicle having only an internal combustion engine, a hybrid vehicle having an internal combustion engine and an electric motor together, and an electric vehicle having only an electric motor, and may include not only an automobile but also a train, a motorcycle, and the like.

At this time, the self-driving vehicle may be regarded as a robot having a self-driving function.

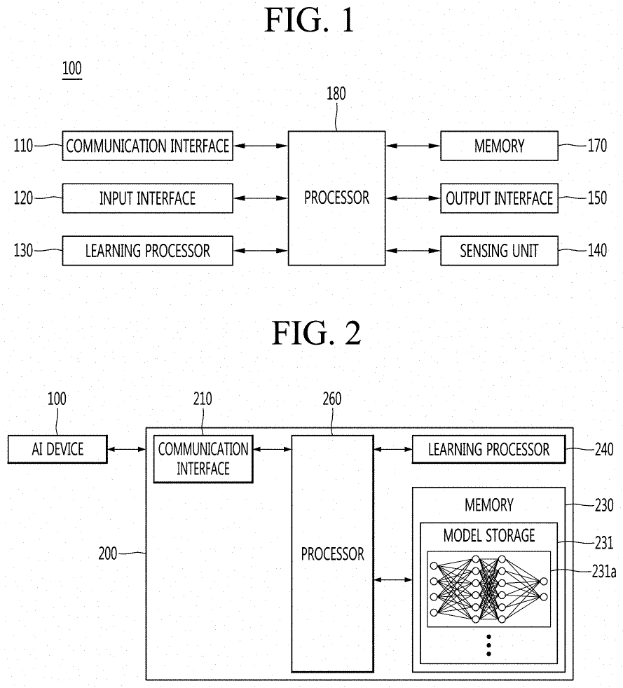

FIG. 1 illustrates an AI device 100 including a robot according to an embodiment of the present disclosure.

The AI device 100 may be implemented by a stationary device or a mobile device, such as a TV, a projector, a mobile phone, a smartphone, a desktop computer, a notebook, a digital broadcasting terminal, a personal digital assistant (PDA), a portable multimedia player (PMP), a navigation device, a tablet PC, a wearable device, a set-top box (STB), a DMB receiver, a radio, a washing machine, a refrigerator, a desktop computer, a digital signage, a robot, a vehicle, and the like.

Referring to FIG. 1, the AI device 100 may include a communication interface 110, an input interface 120, a learning processor 130, a sensing unit 140, an output interface 150, a memory 170, and a processor 180.

The communication interface 110 may transmit and receive data to and from external devices such as other AI devices 100a to 100e and the AI server 200 by using wire/wireless communication technology. For example, the communication interface 110 may transmit and receive sensor information, a user input, a learning model, and a control signal to and from external devices.

The communication technology used by the communication interface 110 includes GSM (Global System for Mobile communication), CDMA (Code Division Multi Access), LTE (Long Term Evolution), 5G, WLAN (Wireless LAN), Wi-Fi (Wireless-Fidelity), Bluetooth™, RFID (Radio Frequency Identification), Infrared Data Association (IrDA), ZigBee, NFC (Near Field Communication), and the like.

The input interface 120 may acquire various kinds of data.

At this time, the input interface 120 may include a camera for inputting a video signal, a microphone for receiving an audio signal, and a user input interface for receiving information from a user. The camera or the microphone may be treated as a sensor, and the signal acquired from the camera or the microphone may be referred to as sensing data or sensor information.

The input interface 120 may acquire a learning data for model learning and an input data to be used when an output is acquired by using a learning model. The input interface 120 may acquire raw input data. In this case, the processor 180 or the learning processor 130 may extract an input feature by preprocessing the input data.

The learning processor 130 may learn a model composed of an artificial neural network by using learning data. The learned artificial neural network may be referred to as a learning model. The learning model may be used to an infer result value for new input data rather than learning data, and the inferred value may be used as a basis for determination to perform a certain operation.

At this time, the learning processor 130 may perform AI processing together with the learning processor 240 of the AI server 200.

At this time, the learning processor 130 may include a memory integrated or implemented in the AI device 100. Alternatively, the learning processor 130 may be implemented by using the memory 170, an external memory directly connected to the AI device 100, or a memory held in an external device.

The sensing unit 140 may acquire at least one of internal information about the AI device 100, ambient environment information about the AI device 100, and user information by using various sensors.

Examples of the sensors included in the sensing unit 140 may include a proximity sensor, an illuminance sensor, an acceleration sensor, a magnetic sensor, a gyro sensor, an inertial sensor, an RGB sensor, an IR sensor, a fingerprint recognition sensor, an ultrasonic sensor, an optical sensor, a microphone, a lidar, and a radar.

The output interface 150 may generate an output related to a visual sense, an auditory sense, or a haptic sense.

At this time, the output interface 150 may include a display for outputting time information, a speaker for outputting auditory information, and a haptic module for outputting haptic information.

The memory 170 may store data that supports various functions of the AI device 100. For example, the memory 170 may store input data acquired by the input interface 120, learning data, a learning model, a learning history, and the like.

The processor 180 may determine at least one executable operation of the AI device 100 based on information determined or generated by using a data analysis algorithm or a machine learning algorithm. The processor 180 may control the components of the AI device 100 to execute the determined operation.

To this end, the processor 180 may request, search, receive, or utilize data of the learning processor 130 or the memory 170. The processor 180 may control the components of the AI device 100 to execute the predicted operation or the operation determined to be desirable among the at least one executable operation.

When the connection of an external device is required to perform the determined operation, the processor 180 may generate a control signal for controlling the external device and may transmit the generated control signal to the external device.

The processor 180 may acquire intention information for the user input and may determine the user's requirements based on the acquired intention information.

The processor 180 may acquire the intention information corresponding to the user input by using at least one of a speech to text (STT) engine for converting speech input into a text string or a natural language processing (NLP) engine for acquiring intention information of a natural language.

At least one of the STT engine or the NLP engine may be configured as an artificial neural network, at least part of which is learned according to the machine learning algorithm. At least one of the STT engine or the NLP engine may be learned by the learning processor 130, may be learned by the learning processor 240 of the AI server 200, or may be learned by their distributed processing.

The processor 180 may collect history information including the operation contents of the AI apparatus 100 or the user's feedback on the operation and may store the collected history information in the memory 170 or the learning processor 130 or transmit the collected history information to the external device such as the AI server 200. The collected history information may be used to update the learning model.

The processor 180 may control at least part of the components of AI device 100 so as to drive an application program stored in memory 170. Furthermore, the processor 180 may operate two or more of the components included in the AI device 100 in combination so as to drive the application program.

FIG. 2 illustrates an AI server 200 connected to a robot according to an embodiment of the present disclosure.

Referring to FIG. 2, the AI server 200 may refer to a device that learns an artificial neural network by using a machine learning algorithm or uses a learned artificial neural network. The AI server 200 may include a plurality of servers to perform distributed processing, or may be defined as a 5G network. At this time, the AI server 200 may be included as a partial configuration of the AI device 100, and may perform at least part of the AI processing together.

The AI server 200 may include a communication interface 210, a memory 230, a learning processor 240, a processor 260, and the like.

The communication interface 210 can transmit and receive data to and from an external device such as the AI device 100.

The memory 230 may include a model storage 231. The model storage 231 may store a learning or learned model (or an artificial neural network 231a) through the learning processor 240.

The learning processor 240 may learn the artificial neural network 231a by using the learning data. The learning model may be used in a state of being mounted on the AI server 200 of the artificial neural network, or may be used in a state of being mounted on an external device such as the AI device 100.

The learning model may be implemented in hardware, software, or a combination of hardware and software. If all or part of the learning models are implemented in software, one or more instructions that constitute the learning model may be stored in memory 230.

The processor 260 may infer the result value for new input data by using the learning model and may generate a response or a control command based on the inferred result value.

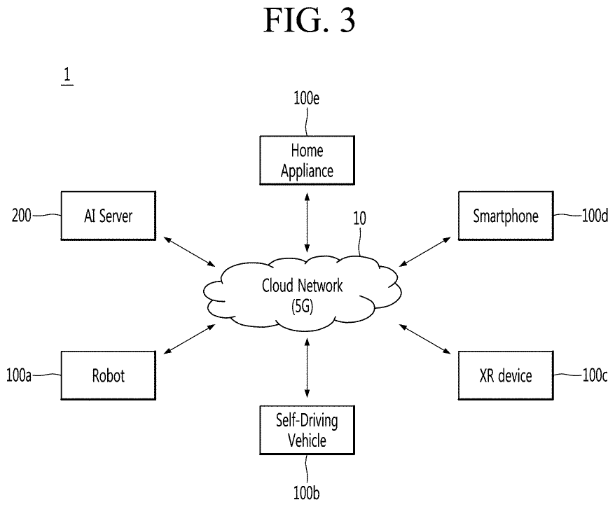

FIG. 3 illustrates an AI system 1 according to an embodiment of the present disclosure.

Referring to FIG. 3, in the AI system 1, at least one of an AI server 200, a robot 100a, a self-driving vehicle 100b, an XR device 100c, a smartphone 100d, or a home appliance 100e is connected to a cloud network 10. The robot 100a, the self-driving vehicle 100b, the XR device 100c, the smartphone 100d, or the home appliance 100e, to which the AI technology is applied, may be referred to as AI devices 100a to 100e.

The cloud network 10 may refer to a network that forms part of a cloud computing infrastructure or exists in a cloud computing infrastructure. The cloud network 10 may be configured by using a 3G network, a 4G or LTE network, or a 5G network.

That is, the devices 100a to 100e and AI server 200 defining the AI system 1 may be connected to each other through the cloud network 10. In particular, each of the devices 100a to 100e and 200 may communicate with each other through a base station, but may directly communicate with each other without using a base station.

The AI server 200 may include a server that performs AI processing and a server that performs operations on big data.

The AI server 200 may be connected to at least one of the AI devices constituting the AI system 1, that is, the robot 100a, the self-driving vehicle 100b, the XR device 100c, the smartphone 100d, or the home appliance 100e through the cloud network 10, and may assist at least part of AI processing of the connected AI devices 100a to 100e.

At this time, the AI server 200 may learn the artificial neural network according to the machine learning algorithm instead of the AI devices 100a to 100e, and may directly store the learning model or transmit the learning model to the AI devices 100a to 100e.

At this time, the AI server 200 may receive input data from the AI devices 100a to 100e, may infer the result value for the received input data by using the learning model, may generate a response or a control command based on the inferred result value, and may transmit the response or the control command to the AI devices 100a to 100e.

Alternatively, the AI devices 100a to 100e may infer the result value for the input data by directly using the learning model, and may generate the response or the control command based on the inference result.

Hereinafter, various embodiments of the AI devices 100a to 100e to which the above-described technology is applied will be described. The AI devices 100a to 100e illustrated in FIG. 3 may be regarded as a specific embodiment of the AI device 100 illustrated in FIG. 1.

The robot 100a, to which the AI technology is applied, may be implemented as a guide robot, a carrying robot, a cleaning robot, a wearable robot, an entertainment robot, a pet robot, an unmanned flying robot, or the like.

The robot 100a may include a robot control module for controlling the operation, and the robot control module may refer to a software module or a chip implementing the software module by hardware.

The robot 100a may acquire state information about the robot 100a by using sensor information acquired from various kinds of sensors, may detect (recognize) surrounding environment and objects, may generate map data, may determine the route and the travel plan, may determine the response to user interaction, or may determine the operation.

The robot 100a may use the sensor information acquired from at least one sensor among the lidar, the radar, and the camera so as to determine the travel route and the travel plan.

The robot 100a may perform the above-described operations by using the learning model composed of at least one artificial neural network. For example, the robot 100a may recognize the surrounding environment and the objects by using the learning model, and may determine the operation by using the recognized surrounding information or object information. The learning model may be learned directly from the robot 100a or may be learned from an external device such as the AI server 200.

At this time, the robot 100a may perform the operation by generating the result by directly using the learning model, but the sensor information may be transmitted to the external device such as the AI server 200 and the generated result may be received to perform the operation.

The robot 100a may use at least one of the map data, the object information detected from the sensor information, or the object information acquired from the external apparatus to determine the travel route and the travel plan, and may control the driving unit such that the robot 100a travels along the determined travel route and travel plan.

The map data may include object identification information about various objects arranged in the space in which the robot 100a moves. For example, the map data may include object identification information about fixed objects such as walls and doors and movable objects such as pollen and desks. The object identification information may include a name, a type, a distance, and a position.

In addition, the robot 100a may perform the operation or travel by controlling the driving unit based on the control/interaction of the user. At this time, the robot 100a may acquire the intention information of the interaction due to the user's operation or speech utterance, and may determine the response based on the acquired intention information, and may perform the operation.

The robot 100a, to which the AI technology and the self-driving technology are applied, may be implemented as a guide robot, a carrying robot, a cleaning robot, a wearable robot, an entertainment robot, a pet robot, an unmanned flying robot, or the like.

The robot 100a, to which the AI technology and the self-driving technology are applied, may refer to the robot itself having the self-driving function or the robot 100a interacting with the self-driving vehicle 100b.

The robot 100a having the self-driving function may collectively refer to a device that moves for itself along the given movement line without the user's control or moves for itself by determining the movement line by itself.

The robot 100a and the self-driving vehicle 100b having the self-driving function may use a common sensing method so as to determine at least one of the travel route or the travel plan. For example, the robot 100a and the self-driving vehicle 100b having the self-driving function may determine at least one of the travel route or the travel plan by using the information sensed through the lidar, the radar, and the camera.

The robot 100a that interacts with the self-driving vehicle 100b exists separately from the self-driving vehicle 100b and may perform operations interworking with the self-driving function of the self-driving vehicle 100b or interworking with the user who rides on the self-driving vehicle 100b.

At this time, the robot 100a interacting with the self-driving vehicle 100b may control or assist the self-driving function of the self-driving vehicle 100b by acquiring sensor information on behalf of the self-driving vehicle 100b and providing the sensor information to the self-driving vehicle 100b, or by acquiring sensor information, generating environment information or object information, and providing the information to the self-driving vehicle 100b.

Alternatively, the robot 100a interacting with the self-driving vehicle 100b may monitor the user boarding the self-driving vehicle 100b, or may control the function of the self-driving vehicle 100b through the interaction with the user. For example, when it is determined that the driver is in a drowsy state, the robot 100a may activate the self-driving function of the self-driving vehicle 100b or assist the control of the driving unit of the self-driving vehicle 100b. The function of the self-driving vehicle 100b controlled by the robot 100a may include not only the self-driving function but also the function provided by the navigation system or the audio system provided in the self-driving vehicle 100b.

Alternatively, the robot 100a that interacts with the self-driving vehicle 100b may provide information or assist the function to the self-driving vehicle 100b outside the self-driving vehicle 100b. For example, the robot 100a may provide traffic information including signal information and the like, such as a smart signal, to the self-driving vehicle 100b, and automatically connect an electric charger to a charging port by interacting with the self-driving vehicle 100b like an automatic electric charger of an electric vehicle.

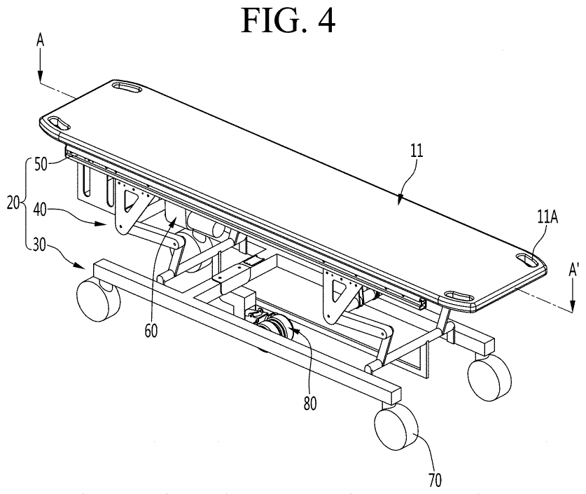

FIG. 4 is a perspective view of a moving bed robot according to an embodiment.

The moving bed robot according to the present embodiment may be the robot 100a having the self-driving function described above. The moving bed robot may be a moving bed.

The moving bed robot according to the present embodiment may include an upper plate 11, a frame 20, and a driving wheel module 80. The moving bed robot according to the present embodiment may further include an actuator 60.

The upper plate 11 may be horizontally disposed. The upper plate 11 may support, from a lower side, a mattress or bedding for the patient to lie down on.

The upper plate 11 may have a substantially rectangular shape. A long side of the upper plate 11 may be formed extend with respect to a first direction, and a short side may be formed to extend with respect to a second direction perpendicular to the first direction. Hereinafter, it is assumed that the first direction is a front-and-rear direction and the second direction is a left-and-right direction.

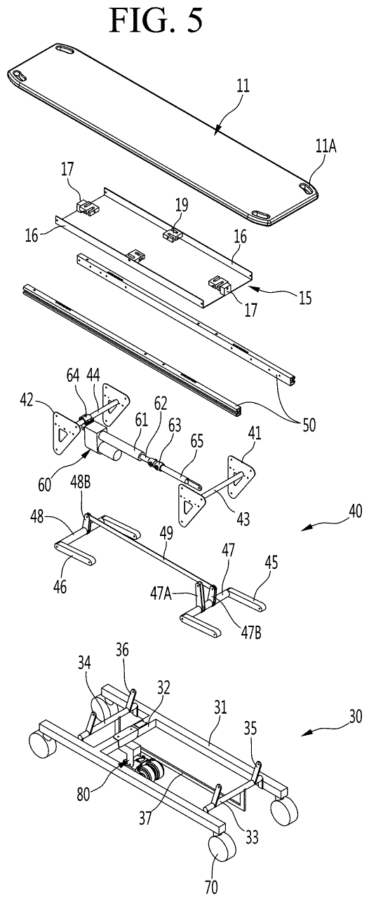

At least one grip hole 11A may be formed in the upper plate 11. Preferably, a plurality of grip holes 11A may be formed. The grip hole 11A may be formed to penetrate the upper plate 11 in a vertical direction. The grip hole 11A may be formed adjacent to a front side edge and/or a rear side edge of the upper plate 11. The grip hole 11A may be locates so as to not overlap a lower plate 15 (see FIG. 5) of the moving bed robot in a vertical direction.

An operator may insert his or her hand into the grip hole 11A and easily push or pull the upper plate 11.

The frame 20 may support the upper plate 11 and the lower plate 15 (see FIG. 5). In more detail, the lower plate 15 may be coupled to an upper portion of the frame 20, and the lower plate 15 may support the upper plate 11. The frame 20 may be disposed below the upper plate 11. That is, the frame 20 may be spaced apart from the upper plate 11, without coming in contact with the upper plate 11.

The frame 20 may be provided with a caster 70. Therefore, the operator may easily move the moving bed robot.

The caster 70 may come in contact with the floor surface. The caster 70 may support the total load of the moving bed robot. The caster 70 is preferably provided as a plurality of casters spaced apart from each other. For example, the plurality of casters may include a pair of front casters and a pair of rear casters.

The frame 20 may include a base frame 30, a connecting frame 40, and a support beam 50.

The base frame 30 may be spaced apart from and below the upper plate 11.

The base frame 30 may be provided with the caster 70. The base frame 30 may be equipped with a driving wheel module 80, which is described below.

The support beam 50 may be provided as a pair of support beams spaced apart in parallel in a left-and-right direction. The support beam 50 may be formed to extend in a front-and-rear direction. The support beam 50 may be coupled to the lower plate 15 (see FIG. 5).

The support beam 50 may be disposed below the upper plate 11. In more detail, the support beam 50 may be disposed below both edges of the upper plate 11. A predetermined gap may be formed between the support beam 50 and the upper plate 11.

The connecting frame 40 may couple the base frame 30 to the support beam 50. The connecting frame 40 may be coupled to the support beam 50 and/or the lower plate 15.

The height of the connecting frame 40 may be adjusted by the actuator 60.

The driving wheel module 80 may drive the movement of the moving bed robot, or may assist in the movement of the moving bed robot. The driving wheel module 80 may be mounted on the frame 20, more specifically, the base frame 30. The configuration and operation of the driving wheel module 80 will be described below.

The actuator 60 may be mounted on the connecting frame 40. The actuator 60 may adjust the height of the connecting frame 40. By driving of the actuator 60, the heights of the upper plate 11 and the lower plate 15 may increase or decrease.

FIG. 5 is an exploded perspective view of the moving bed robot according to the embodiment.

The moving bed robot according to the present embodiment may include a lower plate 15 and a load cell 19.

The lower plate 15 may be disposed horizontally below the upper plate 11. The lower plate 15 may have a substantially rectangular shape.

The size of the lower plate 15 may be smaller than the size of the upper plate 11. In more detail, the length of the lower plate 15 may be shorter than the length of the upper plate 11 with respect to the front-and-rear direction. In addition, the width of the lower plate 15 may be smaller than the width of the upper plate 11 with respect to the left-and-right direction.

The lower plate 15 may be coupled to the upper portion of the frame 20. In more detail, the lower plate 15 may be coupled to the support beam 50. In more detail, the lower plate 15 may include a bent portion 16 bent upward from both edges of the lower plate 15, and the bent portion 16 may be coupled to the support beam 50. The bent portion 16 may be spaced apart from the upper plate 11 in the vertical direction.

In addition, the lower plate 15 may be provided with a protrusion portion 17 protruding upward from the lower plate 15. The protrusion portion 17 may be adjacent to the front and rear edges of the lower plate 15. The protrusion portion 17 may be spaced apart from the upper plate 11 in the vertical direction.

The load cell 19 may be coupled to the bent portion 16 and the protrusion portion 17.

The load cell 19 may be disposed between the upper plate 11 and the lower plate 15. Preferably, the load cell 19 may be spaced apart downward from the upper plate 11, may be spaced apart upward from the lower plate 15. The load cell 19 may detect a lateral force.

The load cell 19 may be provided as a plurality of load cells. Some of the plurality of load cells 19 may detect a force in the front-and-rear direction, and others may detect a force in the left-and-right direction. Since the operation principle of the load cell 19 is well known, detailed description thereof will be omitted.

When the upper plate 11 moves in the horizontal direction with respect to the lower plate 15, the load cell 19 may detect the movement of the upper plate, and the driving wheel module 80 may be driven according to the detection result of the load cell 19.

Meanwhile, the base frame 30 may include a pair of base beams 31 spaced apart in parallel in the left-and-right direction and a connecting beam 32 configured to couple the pair of base beams 31. The pair of base beams 31 and the connecting beam 32 may be integrally formed.

The base beam 31 may be formed to extend in the front-and-rear direction. The cross section of the base beam 31 may be rectangular. The casters 70 may be provided at opposite ends of the base beam 31. In more detail, the casters 70 may be connected to bottom surfaces of the opposite ends of the base beam 31.

The connecting beam 32 may be formed to extend in the left-and-right direction. The cross section of the connecting beam 32 may be rectangular. Opposite ends of the connecting beam 32 may be connected to the pair of base beams 31, respectively.

The connecting beam 32 may be connected to the rear portion of the base beam 31. In more detail, the front-and-rear distance between the rear end of the base beam 31 and the connecting beam 32 may be shorter than the front-and-rear distance between the front end of the base beam 31 and the connecting beam 32.

The driving wheel module 80 may be installed in the connecting beam 32.

The base frame 30 may further include a front base bar 33, a rear base bar 34, a front support 35, and a rear support 36.

The front base bar 33 and the rear base bar 34 may be formed to extend in the left-and-right direction. That is, the front base bar 33 and the rear base bar 34 may be parallel with the connecting beam 32. The cross sections of the front base bar 33 and the rear base bar 34 may be circular. Opposite ends of the front base bar 33 and the rear base bar 34 may be connected to the pair of base beams 31, respectively.

The front base bar 33 may be connected to the front portion of the base beam 31, and the rear base bar 34 may be connected to the rear portion of the base beam 31. The front base bar 33 may be disposed in front of the connecting beam 32, and the rear base bar 34 may be disposed behind the connecting beam 32.

In more detail, with respect to the rear end of the base beam 31, the front-and-rear distance to the connecting beam 32 may be closer than the front-and-rear distance to the front base bar 33 and farther than the front-and-rear distance to the rear base bar 34.

In addition, the front-and-rear distance between the connecting beam 32 and the front base bar 33 may be farther than the front-and-rear distance between the connecting beam 32 and the rear base bar 34. That is, the connecting beam 32 may be closer to the rear base bar 34 than the front base bar 33.

The front support 35 may be formed to be inclined vertically or upwardly from the front base bar 33. Preferably, the front support 35 may be formed in the front base bar 33 to be inclined in a direction in which the height increases toward the front side. The front support 35 may be provided as a pair of front supports spaced apart in parallel in the left-and-right direction.

The rear support 36 may be formed to be inclined vertically or upwardly from the rear base bar 34. Preferably, the rear support 36 may be formed in the rear base bar 34 to be inclined in a direction in which the height increases toward the front side. The rear support 36 may be provided as a pair of rear supports spaced apart in parallel in the left-and-right direction.

The base frame 30 may further include a reinforcement frame 37 configured to couple the front base bar 33 to the rear base bar 34.

Meanwhile, the support beam 50 may be coupled to the lower plate 15. In more detail, the support beam 50 may be coupled to the bent portion 16. For example, the support beam 50 may be coupled to the outside of the bent portion 16.

The support beam 50 may support the upper plate 11 and the lower plate 15. In more detail, the lower plate 15 may be coupled to the support beam 50, and the lower plate 15 may support the upper plate 11.

Meanwhile, the connecting frame 40 may include a front frame 41, a rear frame 42, a front connecting bar 43, a rear connecting bar 44, a front link 45, and a rear link 46. The connecting frame 40 may further include a front link bar 47 and a rear link bar 48.

The front frame 41 may be provided as a pair of front frames spaced apart in parallel in the left-and-right direction. The front frame 41 may have a panel shape having a predetermined thickness in the left-and-right direction. The front frame 41 may be vertically disposed.

The front frame 41 may be coupled to the lower plate 15, more specifically, the bent portion 16. A part of the upper portion of the front frame 41 may be disposed between the bent portion 16 and the support beam 50, and may be coupled to the bent portion 16 and the support beam 50.

The lower portion of the front frame 41 may be rotatably connected to the front link 45, which will be described below. The front frame 41 and the front link 45 may rotate with respect to a rotational axis extending in the left-and-right direction.

The front connecting bar 43 may couple the pair of front frames 41. The front connecting bar 43 may be formed to extend in the left-and-right direction. The front connecting bar 43 may be horizontal. The front connecting bar 43 may be disposed below the lower plate 15 and the support beam 50.

The rear frame 42 may be provided as a pair of rear frames spaced apart in parallel in the left-and-right direction. The rear frame 42 may have a panel shape having a predetermined thickness in the left-and-right direction. The rear frame 42 may be vertically disposed.

The rear frame 42 may be disposed behind the front frame 41.

The rear frame 42 may be coupled to the lower plate 15, more specifically, to the bent portion 16. A part of the upper portion of the rear frame 42 may be disposed between the bent portion 16 and the support beam 50, and may be coupled to the bent portion 16 and the support beam 50.

The lower portion of the rear frame 42 may be rotatably connected to the rear link 46, which will be described below. The rear frame 42 and the rear link 46 may rotate with respect to a rotational axis extending in the left-and-right direction.

The rear connecting bar 44 may couple the pair of rear frames 42. The rear connecting bar 44 may be formed to extend in the left-and-right direction. The rear connecting bar 44 may be horizontal. The rear connecting bar 44 may be disposed below the lower plate 15 and the support beam 50. The rear connecting bar 44 may be disposed behind the front connecting bar 43.

Meanwhile, the front link 45 may couple the front support 35 to the front frame 41. The front link 45 may be formed to extend in the front-and-rear direction. The front link 45 may be provided as a pair of front links spaced apart in parallel in the left-and-right direction.

The front link 45 may be rotatably connected to each of the front support 35 and the front frame 41. The front link 45 and the front support 35 may rotate with respect to a rotational axis extending in the left-and-right direction. The front link 45 and the front frame 41 may rotate with respect to the rotational axis extending in the left-and-right direction.

In more detail, the front end of the front link 45 may be rotatably connected to the upper end of the front support 35. The rear end of the front link 45 may be rotatably connected to the lower portion of the front frame 41.

The front link bar 47 may couple the pair of front links 45. The front link bar 47 may rotate together with the front link 45.

The front link bar 47 may be provided with a front connecting lever 47B to which a coupler 49, which will be described below, is connected. The front connecting lever 47B may be formed to be inclined vertically or upwardly to the front link bar 47.

The rear link 46 may couple the rear support 36 to the rear frame 42. The rear link 46 may be formed to extend in the front-and-rear direction. The rear link 46 may be provided as a pair of rear links spaced apart in parallel in the left-and-right direction.

The rear link 46 may be disposed behind the front link 45.

The rear link 46 may be rotatably connected to each of the rear support 36 and the rear frame 42. The rear link 46 and the rear support 36 may rotate with respect to a rotational axis extending in the left-and-right direction. The rear link 46 and the rear frame 42 may rotate with respect to the rotational axis extending in the left-and-right direction.

In more detail, the front end of the rear link 46 may be rotatably connected to the upper end of the rear support 36. The rear end of the rear link 46 may be rotatably connected to the lower portion of the rear frame 42.

The rear link bar 48 may couple the pair of rear links 46. The rear link bar 48 may rotate together with the rear link 46.

The rear link bar 48 may be disposed behind the front link bar 47.

The rear link bar 48 may be provided with a rear connecting lever 48B to which a coupler 49, which will be described below, is connected. The rear connecting lever 48B may be formed to be inclined vertically or upwardly to the rear link bar 48.

The connecting frame 40 may further include a coupler 49. The coupler 49 may be formed to extend in the front-and-rear direction. The coupler 49 may have a predetermined thickness in the horizontal direction. The coupler 49 may interwork with the rotation of the front link bar 47 and the rear link bar 48.

In more detail, the coupler 49 may couple the front connecting lever 47B to the rear connecting lever 48B. The coupler 49 may be rotatably connected to the front connecting lever 47B and the rear connecting lever 48B. The coupler 49 and the front connecting lever 47B may rotate with respect to the rotational axis extending in the left-and-right direction. The coupler 49 and the rear connecting lever 48B can rotate with respect to the rotational axis extending in the left-and-right direction.

The front end of the coupler 49 may be rotatably connected to the upper end of the front connecting lever 47B, and the rear end of the coupler 49 may be rotatably connected to the upper end of the rear connecting lever 48B.

Meanwhile, the actuator 60 may be mounted on one of the front connecting bar 43 and the rear connecting bar 44. In addition, a power transmission lever 47A to which the power of the actuator 60 is transmitted may be formed on one of the front link bar 47 and the rear link bar 48.

When the actuator 60 is connected to the front connecting bar 43, the power transmission lever 47A may be formed in the rear link bar 48. Meanwhile, when the actuator 60 is connected to the rear connecting bar 44, the power transmission lever 47A may be formed in the front link bar 47. Hereinafter, a case where the actuator 60 is connected to the rear connecting bar 44 and the power transmission lever 47A is formed in the front link bar 47 will be described as an example.

The actuator 60 may be connected to the rear connecting bar 44. In more detail, the bracket 64 to which the actuator 60 is connected may be mounted on the rear connecting bar 44.

The bracket 64 may be coupled by wrapping the circumference of the rear connecting bar 44. The actuator 60 may be rotatably connected to the connecting bar 44 via the bracket 64 being rotatably connected to the connecting bar 44. The bracket 64 may protrude rearward from the actuator 60. The bracket connecting portion 64 and the connecting bar 44 may rotate with respect to a rotational axis extending in the left-and-right direction.

The actuator 60 may include a cylinder 61 and a piston 62. The cylinder 61 may be formed to extend in the front-and-rear direction. The piston 62 may be moved in the longitudinal direction, that is, the front-and-rear direction of the cylinder 61 in a state where a part of the piston 62 is inserted into the cylinder 61.

The piston 62 may be connected to a connecting rod 65 by a connector 63. The connecting rod 65 may extend in the longitudinal direction of the piston 62 and the cylinder 61.

The connecting rod 65 may be rotatably connected to the power transmission lever 47A formed in the front link bar 47. Therefore, the power of the actuator 60 may be transmitted to the power transmission lever 47A.

The power transmission lever 47A may be formed in the front link bar 47. The power transmission lever 47A may be formed to be inclined vertically or upwardly from the front link bar 47. Preferably, the power transmission lever 47A may be formed to be inclined in a direction in which the height increases toward the rear side. The power transmission lever 47A may be spaced apart from the front connecting lever 47B in the left-and-right direction.

The power transmission lever 47A, the front connecting lever 47B, the front link bar 47, and the front link 45 may rotate together. The rear connecting lever 48B, the rear link bar 48, and the rear link 46 may rotate together.

Therefore, when the connecting rod 65 moves forward or backward, the power transmission lever 47A, the front link bar 47 and the front link 45, and the front connecting lever 47B may rotate together. In addition, since the front connecting lever 47B and the rear connecting lever 48B are connected by the coupler 49, the rear connecting lever 48B, the rear link bar 48, and the rear link 46 may rotate together.

Meanwhile, the front support 35 connected to the front link 45 may be fixed to the front base bar 33 and may not rotate. In addition, the front frame 41 connected to the front link 45 may be coupled to the lower plate 15 and/or the support beam 50 and may not rotate. In addition, the rear support 36 connected to the rear link 46 may be fixed to the rear base bar 34 and may not rotate. In addition, the rear frame 42 connected to the rear link 46 may be coupled to the lower plate 15 and/or the support beam 50 and may not rotate.

Therefore, when the actuator 60 pushes the connecting rod 65, the front frame 41, the rear frame 42, the support beam 50, the lower plate 15, and the upper plate 11 may move upward without rotation. That is, the height of the moving bed robot may be increased.

On the contrary, when the actuator 60 pulls the connecting rod 65, the front frame 41, the rear frame 42, the support beam 50, the lower plate 15, and the upper plate 11 may move downward without rotation. That is, the height of the moving bed robot may be decreased.

Therefore, the height of the moving bed robot may be easily adjusted by the actuator 60.

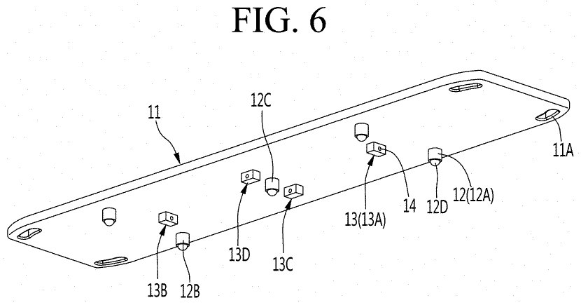

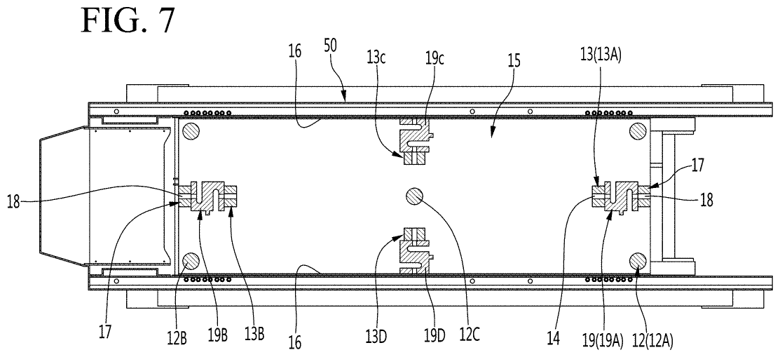

FIG. 6 is a view illustrating the bottom surface of the upper plate according to an embodiment, and FIG. 7 is a cross-sectional view taken along line A-A′ of FIG. 4.

A plurality of supporters 12 may be formed on the upper plate 11. The plurality of supporters 12 may protrude toward the lower plate 15 from the bottom surface of the upper plate 11. The plurality of supporters 12 may come in contact with the lower plate 15. The plurality of supporters 12 may support the upper plate 11 on the lower plate 15, and may space the upper plate 11 apart from the lower plate 15.

The plurality of supporters 12 may be spaced apart from each other. The plurality of supporters 12 may be evenly arranged such that the upper plate 11 is horizontally maintained without being inclined.

For example, the plurality of supporters 12 may include a pair of front supporters 12A in contact with a portion adjacent to the front edge of the upper surface of the lower plate 15, a pair of rear supporters 12B in contact with a portion adjacent to the rear edge of the upper surface of the lower plate 15, and a center supporter 12C in contact with the central portion of the upper surface of the lower plate 15.

Each of the supporters 12 may include a contact portion 12D. The contact portion 12D may be in contact with the upper surface of the lower plate 15. The contact portion 12D may have a smaller cross-sectional area toward the lower side. The contact portion 12D may include a part of a spherical surface. The contact portion 12D is preferably in point contact with the lower plate 15.

Therefore, the contact area between the supporter 12 and the lower plate 15 may be minimized. Therefore, the frictional resistance generated between the contact portion 12D and the lower plate 15 when the upper plate 11 is moved relative to the lower plate 15 may be minimized.

A plurality of protrusion portions 13 may be formed on the upper plate 11. The plurality of protrusion portions 13 may protrude from the bottom surface of the upper plate 11 toward the lower plate 15.

The protrusion portion 13 may be spaced apart from the supporter 12 in the horizontal direction. The supporter 12 may be spaced apart from the lower plate 15 in the vertical direction. The protrusion portion 13 may move with the upper plate 11 and apply a force to the load cell 19.

The protrusion portion 13 may be coupled to the load cell 19. In more detail, the protrusion portion 13 may be provided with a coupling hole 14 to be coupled to the load cell 19. A coupling member such as a screw may be coupled to the load cell 19 by passing through the coupling hole 14.

The plurality of protrusion portions 13 may be spaced apart from each other. The number of protrusion portions 13 may be equal to the number of load cells 19. For example, the plurality of protrusion portions 13 may include a front protrusion portion 13A applying a force to a front load cell 19A, a rear protrusion portion 13B applying a force to a rear load cell 19B, a left protrusion portion 13C applying a force to a left load cell 19C, and a right protrusion portion 13D applying a force to a right load cell 19D.

The front protrusion portion 13A and the rear protrusion portion 13B may be disposed on a straight line in the front-and-rear direction. The left protrusion portion 13C and the right protrusion portion 13D may be disposed on a straight line in the right-and-left direction.

The front protrusion portion 13A and the rear protrusion portion 13B may apply a force to the load cell 19 in the front-and-rear direction. The left protrusion portion 13C and the right protrusion portion 13D may apply a force to the load cell 19 in the left-and-right direction.

Meanwhile, as described above, the lower plate 15 may include a bent portion 16 bent upward from both edges of the lower plate 15, and a protrusion portion 17 protruding upward from the front and rear edges of the lower plate 15.

The load cell 19 may be coupled to the bent portion 16 and the protrusion portion 17. The bent portion 16 and the protrusion portion 17 may be referred to as fixing portions 16 and 17. Coupling holes 18 to which the load cell 19 is coupled may be formed in the fixing portions 16 and 17. A coupling member such as a screw may be coupled to the load cell 19 by passing through the coupling hole.

The load cell 19 may be disposed between the upper plate 11 and the lower plate 15. The load cell 19 may be spaced apart from the upper plate 11 and the lower plate 15 in the vertical direction. The load cell 19 may detect a lateral force.

The load cell 19 may be disposed between the protrusion portions 13 protruding downward from the upper plate 11 and the fixing portions 16 and 17 bent or protruding upward from the lower plate 15. In more detail, the load cell 19 may be disposed between the protrusion portions 13 and the fixing portions 16 and 17 with respect to the horizontal direction. The outside of the load cell 19 may be coupled to the protrusion portion 13, and the inside of the load cell 19 may be coupled to the fixing portions 16 and 17.

When the upper plate 11 moves relative to the lower plate 15, the load cell 19 may be deformed between the protrusion portions 13 and the fixing portions 16 and 17. That is, the upper plate 11 may be movable within the deformation range of the load cell 19 with respect to the lower plate 15.

Therefore, as the external force applied to the upper plate 11 increases, the deformation of the load cell 19 may increase. In addition, the deformation direction and degree of each load cell 19 may be different according to the direction of the external force applied to the upper plate 11.

The load cell 19 may be provided as a plurality of load cells. The plurality of load cells 19 may include first load cells 19A and 19B configured to detect a force acting in the front-and-rear direction, and second load cells 19C and 19D configured to detect a force acting in the left-and-right direction.

The first load cells 19A and 19B may be disposed at the central portion of the lower plate 15 with respect to the left-and-right direction. The second load cells 19C and 19D may be disposed at the central portion of the lower plate 15 with respect to the front-and-rear direction.

The first load cells 19A and 19B may include a front load cell 19A adjacent to the front edge of the lower plate 15 and a rear load cell 19B adjacent to the rear edge of the lower plate 15.

The front load cell 19A may be coupled to the protrusion portion 17 adjacent to the front edge of the lower plate 15. The rear load cell 19B may be coupled to the protrusion portion 17 adjacent to the rear edge of the lower plate 15.

When the upper plate 11 moves forward with respect to the lower plate 15, the front protrusion portion 13A may push the front load cell 19A forward, and the rear protrusion portion 13B may pull the rear load cell 19B forward. Therefore, the front load cell 19A may be compressed in the front-and-rear direction, and the rear load cell 19B may be stretched in the front-and-rear direction.

When the upper plate 11 moves backward with respect to the lower plate 15, the front protrusion portion 13A may pull the front load cell 19A backward, and the rear protrusion portion 13B may push the rear load cell 19B backward. Therefore, the front load cell 19A may be stretched in the front-and-rear direction, and the rear load cell 19B may be compressed in the front-and-rear direction.

The second load cells 19C and 19D may include a left load cell 19C adjacent to the left edge of the lower plate 15, and a right load cell 19D adjacent to the right edge of the lower plate 15.

The left load cell 19C may be coupled to the bent portion 16 formed at the left edge of the lower plate 15. The right load cell 19D may be coupled to the bent portion 16 adjacent to the right edge of the lower plate 15.

When the upper plate 11 is rotated to the left relative to the lower plate 15, the left protrusion portion 13C may push the left load cell 19C in the left direction, and the right protrusion portion 13D may pull the right load cell 19D in the left direction. Therefore, the left load cell 19C may be compressed in the left-and-right direction, and the right load cell 19D may be stretched in the left-and-right direction.

When the upper plate 11 is rotated to the right relative to the lower plate 15, the left protrusion portion 13C may pull the left load cell 19C in the right direction, and the right protrusion portion 13D may push the right load cell 19D in the right direction. Therefore, the left load cell 19C may be stretched in the left-and-right direction, and the right load cell 19D may be compressed in the left-and-right direction.

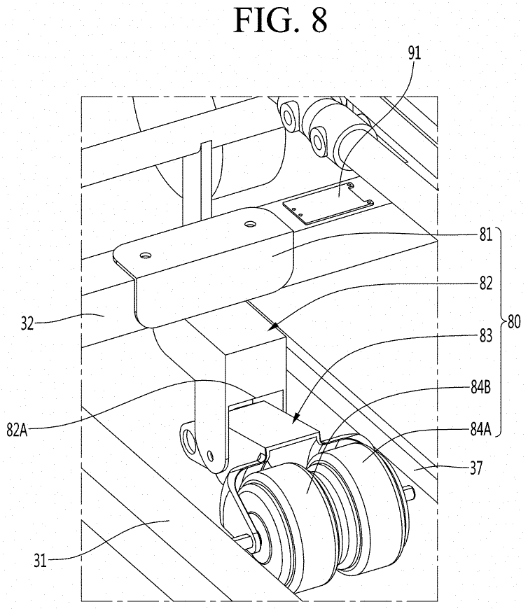

FIG. 8 is an enlarged view illustrating a driving wheel module and the surroundings thereof according to an embodiment.

As described above, the driving wheel module 80 may drive the moving bed robot or may assist the movement of the moving bed robot.

The driving wheel module 80 may include fixing brackets 81 and 82, moving brackets 83, and driving wheels 84A and 84B.

The fixing brackets 81 and 82 may be coupled and fixed to the base frame 30, more particularly, the connecting beam 32.

The fixing brackets 81 and 82 may include a coupling portion 81 coupled to the connecting beam 32, and a connecting portion 82 connected to the coupling portion 81 and rotatably connected to the moving bracket 83.

The coupling portion 81 may include an upper cover portion covering a part of the upper surface of the connecting beam 32, and a front cover portion bent downward from the upper cover portion to cover a part of the front surface of the connecting beam

The connecting portion 82 may have an approximately “−¬” shape. The bottom surface and back surface of the connecting portion 82 may be opened. In more detail, the connecting portion 82 may include an upper part connected to the coupling portion 81 and formed to extend in the front-and-rear direction, and a front part formed to extend downward from the front end of the upper part. The upper part may be connected to the coupling portion 81, more specifically, the front cover portion.

The fixing brackets 81 and 82 may be provided with openings 82A for preventing interference with the moving brackets 83. In more detail, the openings 82A may be formed in the connecting portion 82, and may be connected to the opened bottom surface of the connecting portion 82. In more detail, the opening 82A may be formed on the front surface of the front part, and may be connected to the opened bottom surface of the front part.

The moving bracket 83 may be rotatably connected to the fixing brackets 81 and 82, more specifically, the connecting portion 82.

The moving bracket 83 may rotate about a rotational axis extending in the left-and-right direction with respect to the fixing brackets 81 and 82. The moving bracket 83 may rotate in the vertical direction. A part of the moving bracket 83 may be disposed in the opening 82A.

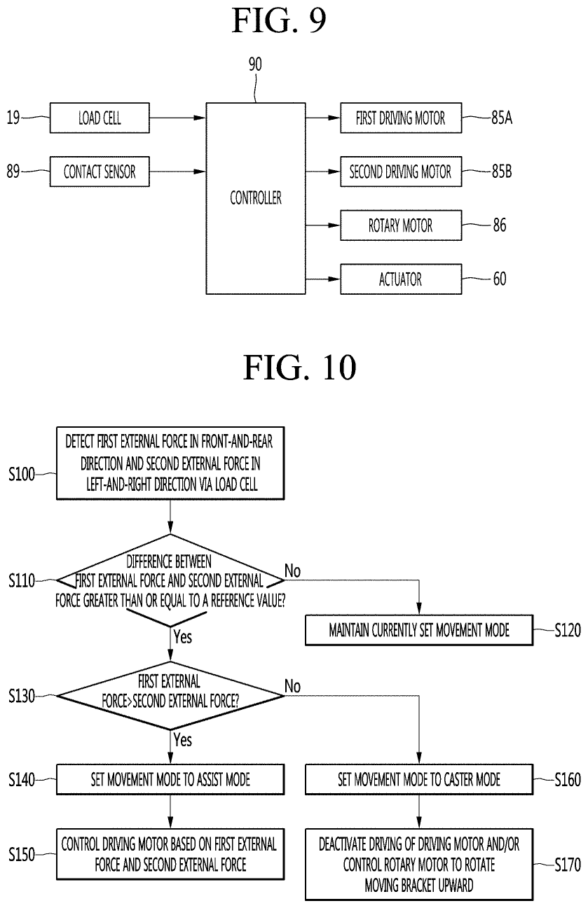

The driving wheel module 80 may further include a rotary motor 86 (see FIG. 9). The rotary motor 86 may rotate the moving bracket 83 in the vertical direction. The rotary motor 86 may be installed in the fixing brackets 81 and 82.

The rotary motor 86 may rotate the moving bracket 83 upward such that the driving wheels 84A and 84B are spaced apart from the floor surface, and may rotate the moving bracket 83 downward such that the driving wheels 84A and 84B are in contact with the floor surface.

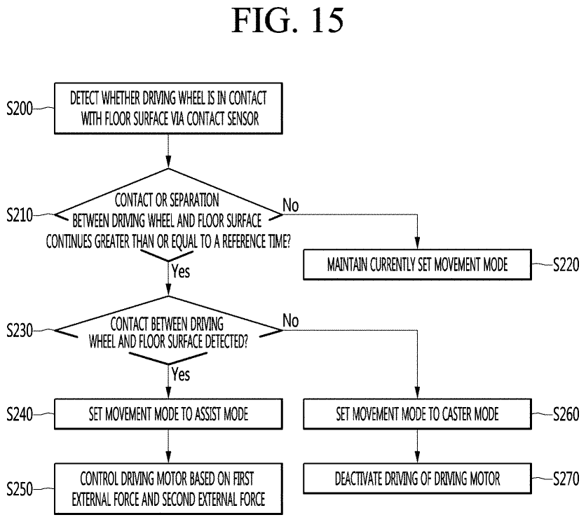

In some embodiments, the driving wheel module 80 may not include the moving bracket 83 and the rotary motor 86. In this case, the driving wheels 84A and 84B may be connected to the fixing brackets 81 and 82 or a separate bracket extending from the fixing brackets 81 and 82. When the moving bracket 83 and the rotary motor 86 are not included, height adjustment of the driving wheels 84A and 84B may be impossible and, as a result, the driving wheels 84A and 84B may or may not be in contact with the floor surface according to the characteristics of the floor surface. A controller 90, which will be described below, may detect whether the driving wheels 84A and 84B are in contact with the floor surface via a contact sensor 89, thereby adjusting the movement mode of the moving bed robot. An embodiment related thereto will be described below with reference to FIGS. 15 to 17.

The driving wheels 84A and 84B may be connected to the moving bracket 83. The driving wheels 84A and 84B may rotate about a rotational axis extending in the left-and-right direction with respect to the moving bracket 83.

The driving wheels 84A and 84B may be disposed in front of the fixing brackets 81 and 82.

The driving wheels 84A and 84B may be provided as a pair of driving wheels spaced apart in the left-and-right direction. The pair of driving wheels 84A and 84B may include a first driving wheel 84A and a second driving wheel 84B.

The rotational shaft of the first driving wheel 84A and the rotational shaft of the second driving wheel 84B may be disposed on a straight line. The first driving wheel 84A and the second driving wheel 84B may rotate independently of each other.

The driving wheel module 80 may further include driving motors 85A and 85B (see FIG. 9). The driving motors 85A and 85B may rotate the driving wheels 84A and 84B. The driving motors 85A and 85B may be installed in the moving bracket 83.

The driving motors 85A and 85B may be provided as a pair of driving motors and may rotate the pair of driving wheels 84A and 84B. In more detail, the pair of driving motors 85A and 85B may include a first driving motor 85A configured to rotate the first driving wheel 84A and a second driving motor configured to rotate the second driving wheel 84B.

When the moving bed robot moves straight, the driving motors 85A and 85B may rotate the pair of driving wheels 84A and 84B in the same direction. The driving motors 85A and 85B may rotate the pair of driving wheels 84A and 84B in opposite directions when the moving bed robot is turned.

The driving wheel module 80 may further include a contact sensor 89 (see FIG. 9). The contact sensor 89 may detect whether the driving wheels 84A and 84B are in contact with the floor surface. The type of the contact sensor 89 is not limited. In some embodiments, the contact sensor 89 may include a proximity sensor disposed on the bottom of the moving bracket 83.

Although not shown, in some embodiments, the moving bed robot may not include the driving wheel module 80 shown in FIG. 8. In this case, a plurality of casters 70 may function as the driving wheels of the moving bed robot, and the moving bed robot may include at least one driving motor for rotating at least two casters 70 among the plurality of casters 70. For example, the moving bed robot may include driving motors equal in number to the number of casters, include one driving motor per a pair of casters or include only one driving motor for rotating all the plurality of casters.

FIG. 9 is a control block diagram of the moving bed robot according to an embodiment.

The control components of the moving bed robot shown in FIG. 9 are examples for convenience of description and the moving bed robot may include more or fewer components than the components shown in FIG. 9.

In addition, the moving bed robot according to the embodiment of the present disclosure may be included in the AI device 100 shown in FIG. 1 and the control components shown in FIG. 1 and the description thereof are similarly applicable to the moving bed robot according to the present embodiment.

The moving bed robot according to the present embodiment may include a controller 90. The controller 90 may include at least one processor. The controller 90 may include a printed circuit board (PCB) 91 (see FIG. 8) disposed on the upper surface of the connecting beam 32.

For example, the at least one processor may include the processor 180 and the learning processor 130 of the AI device 100 shown in FIG. 1. Each of the at least one processor may be implemented as an integrated circuit, a microcomputer, a CPU, an application processor (AP), an application specific integrated circuit (ASIC), etc.

The controller 90 may control the rotary motor 86 to rotate the moving bracket 83 upward or downward. That is, the controller 90 may control the rotary motor 86 to bring the driving wheels 84A and 84B into contact with the floor surface or separate the driving wheels 84A and 84B from the floor surface.

The controller 90 may control the moving bed robot to any one of a traveling mode, an assist mode or a caster mode.

The traveling mode may mean mode in which the moving bed robot autonomously travels by the driving wheel module 80, by driving the driving wheel module 80 even if external force is not applied to the moving bed robot. Accordingly, the traveling mode is advantageous in that the moving bed robot may travel without applying external force by an operator.

The assist mode may mean a mode in which the driving wheel module 80 assists movement of the moving bed robot, by driving the driving wheel module 80 according to the magnitude and direction of external force applied to the upper plate 11 of the moving bed robot. Accordingly, the assist mode is advantageous in that the moving bed robot may easily move without large force of an operator.

The caster mode may mean a mode in which the driving wheel module 80 does not intervene in movement of the moving bed robot. Accordingly, the caster mode is advantageous in that the movement direction of the moving bed robot is not limited to the directions of the driving wheels 84A and 84B. For example, in the caster mode, the operator may move the moving bed robot from side to side.

In the traveling mode or the assist mode, the controller 90 may control the rotary motor 86 to rotate the moving bracket 83 downward and bring the driving wheels 84A and 84B into contact with the floor surface. Accordingly, the moving bed robot may move by rotation force of the driving wheels 84A and 84B.

In the caster mode, the controller 90 may control the rotary motor 86 to rotate the moving bracket 83 upward, and separate the driving wheels 84A and 84B from the floor surface. Accordingly, the driving wheels 84A and 84B may not intervene in movement of the moving bed robot.

The controller 90 may electrically communicate with the contact sensor 89, and receive the result of detection of the contact sensor 89. Accordingly, the controller 90 may determine whether the driving wheels 84A and 84B are in contact with the floor surface.

In the traveling mode or the assist mode, the controller 90 may communicate with the contact sensor 89 to control the rotary motor 86 such that the driving wheels 84A and 84B are kept in contact with the floor surface. As a result, the moving bed robot may reliably travel or movement thereof may be assisted when the floor surface is curved or uneven.

The controller 90 may receive an electrical signal from a load cell 19. Preferably, the controller 90 may receive the electrical signal of the load cell in the traveling mode or the assist mode.

The controller 90 may calculate the magnitude and direction of external force applied to the upper plate 11 based on the signal of the load cell 19.

The controller 90 may control rotation of the driving motors 85A and 85B. More specifically, the controller 90 may receive the electrical signal of the load cell 19 and control rotation of the driving motors 85A and 85B.

The controller 90 may control the rotation speed of the driving motors 85A and 85B in proportion to the magnitude of external force applied to the upper plate 11. That is, when the operator weakly pushes or pulls the upper plate 11, the controller 90 may slowly rotate the driving wheels 84A and 84B, and, when the upper plate 11 is strongly pushed or pulled, the controller 90 may rapidly rotate the driving wheels 84A and 84B.

Specifically, in the assist mode, when external force applied to the upper plate 11 is detected via the load cell 19, the controller 90 may adjust the rotation speed of at least one of the first driving motor 85A and the second driving motor 85B based on the magnitude and direction of the detected external force.

When the magnitude of the detected external force is equal to or greater than a reference magnitude, the controller 90 may adjust the rotation speed of at least one of the first driving motor 85A and the second driving motor 85B to increase the movement speed in the direction of the detected external force. At this time, increase in movement speed (acceleration) may be proportional to the magnitude of the external force.

For example, when external force having a reference magnitude or more is detected in a first direction in a state in which the moving bed robot travels in the first direction, the controller 90 may control the driving motors 85A and 85B to increase the movement speed in the first direction.

Alternatively, when external force having a reference magnitude or more is detected in a direction opposite to the first direction in a state in which the moving bed robot travels in the first direction, the controller 90 may control the driving motors 85A and 85B to increase the movement speed in the direction opposite to the first direction, that is, decrease the movement speed in the first direction.

Alternatively, when external force having a reference magnitude or more is detected in a second direction perpendicular to the first direction in a state in which the moving bed robot travels in the first direction, the controller 90 may control the driving motors 85A and 85B to maintain (gradually decrease) the movement speed in the first direction and increase the movement speed in the second direction. Meanwhile, in order to adjust the movement speed in the second direction, the controller 90 may differently control driving of the first driving motor 85A and the second driving motor 85B.

In contrast, when external force is not detected via the load cell 19 or when the magnitude of the detected external force is less than the reference magnitude, the controller 90 may maintain the rotation speed of the driving motors 85A and 85B or gradually decrease the rotation speed.

The controller 90 may control the rotation directions of the driving motors 85A and 85B according to the direction of the external force applied to the upper plate 11.

When the operator pushes or pulls the upper plate 11 forward and backward, the upper plate 11 may move forward and backward with respect to the lower plate 15 and the first load cells 19A and 19B may be deformed. More specifically, the first load cells 19A and 19B may be compressed or extended in the front-and-rear direction.

In this case, the controller 90 may control the driving motors 85A and 85B to rotate the driving wheels 84A and 84B such that the moving bed robot moves forward or backward. That is, the controller 90 may rotate the first driving wheels 84A and the second driving wheels 84B in the same direction.

The operator may push or pull the upper plate 11 to change the movement direction of the moving bed robot. That is, the operator may rotate the moving bed robot to the left or right, and the upper plate 11 may rotate while moving forward and backward with respect to the lower plate 15. Accordingly, the first load cells 19A and 19B and the second load cells 19C and 19D may be deformed. More specifically, the first load cells 19A and 19B may be compressed or extended in the front-and-rear direction and the second load cells 19C and 19D may be compressed or extended in the left-and-right direction.

In this case, the controller 90 may control the driving motors 85A and 85B to rotate the driving wheels 84A and 84B such that the moving bed robot turns left or right. That is, the controller 90 may rotate the first driving wheel 84A and the second driving wheel 84B in opposite directions. Therefore, the rotation radius of the moving bed robot may decrease and easy direction change is possible.

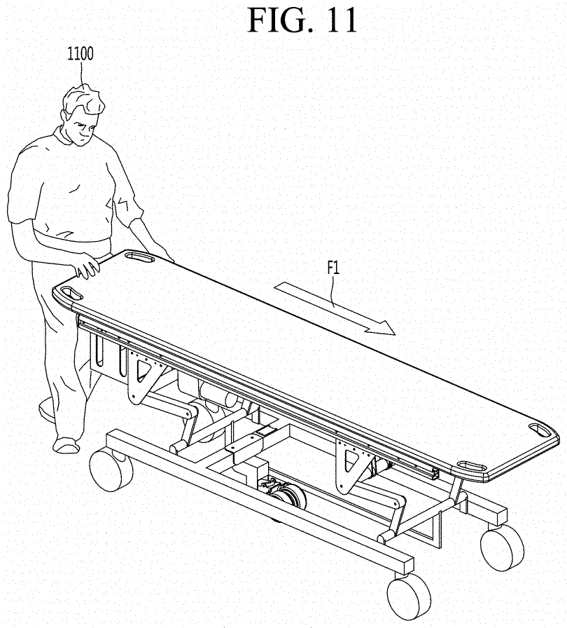

Meanwhile, in some embodiments, the controller 90 may control switching operation of the assist mode and the caster mode based on the direction of the external force detected via the load cell 19. Embodiments related thereto will be described with reference to FIGS. 10 to 14.

Meanwhile, the controller 90 may control the actuator 60 to adjust the height of the moving bed robot. More specifically, the controller 90 may control the actuator 60 to push the connecting rod 65, thereby increasing the height of the connecting frame 40 and move upward the upper plate 11 and the lower plate 15. In contrast, the controller 90 may control the actuator 60 to pull the connecting rod 65 to decrease the height of the connecting frame 65 and move downward the upper plate 11 and the lower plate 15.

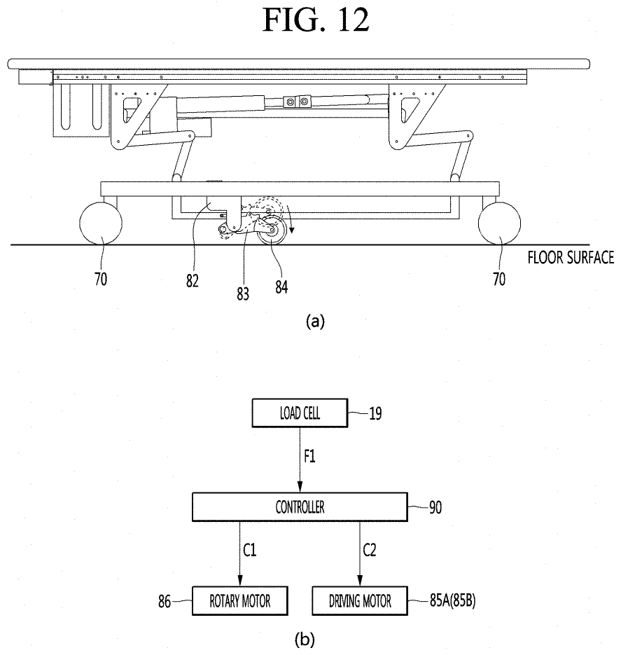

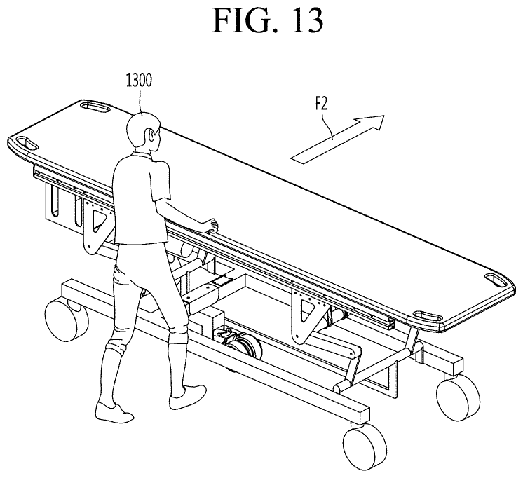

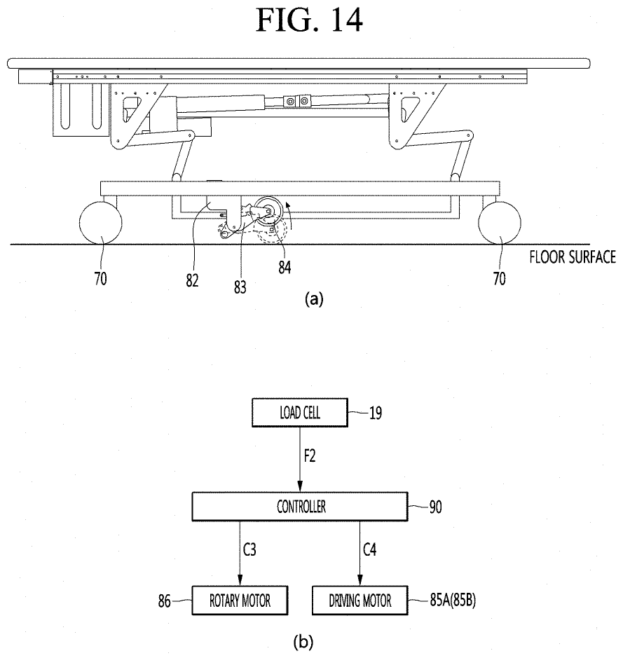

FIG. 10 is a flowchart illustrating movement mode switching operation of a moving bed robot. FIGS. 11 to 12 are views illustrating examples of switching a movement mode of a moving bed robot to an assist mode. FIGS. 13 to 14 are views illustrating examples of switching a movement mode of a moving bed robot to a caster mode.

Referring to FIG. 10, the moving bed robot may detect external force applied to the moving bed robot via the load cell 19 (S100).

The controller 90 may detect first external force in the front-and-rear direction via some load cells (e.g., the front load cell 19A and the rear load cell 19B) of the plurality of load cells provided in the moving bed robot and detect second external force in the left-and-right direction via the remaining load cells (e.g., the left load cell 19C and the right load cell 19D).

The moving bed robot is generally moved in the front-and-rear direction during long-distance movement or rapid movement. That is, a user (or an operator) may apply external force to the moving bed robot in the front-and-rear direction to move the moving bed robot.

In addition, the moving bed robot may be moved in the left-and-right direction during movement of a relatively short distance or movement of a relatively low speed, such as storage or installation position adjustment. That is, the user (or the operator) may apply external force to the moving bed robot in the left-and-right direction to move the moving bed robot. The forward-backward direction and the left-and-right direction are defined in FIG. 4.

That is, in the case where the first external force is greater than the second external force, movement of a relatively long distance or movement of a relatively high speed may be necessary. In this case, the moving bed robot may operate in the assist mode for assisting movement to reduce a user's burden (exhaustion of physical strength, etc.).

In contrast, in the case where the second external force is greater than the first external force, movement of a relatively short distance or movement of a relatively low speed may be necessary. In this case, the moving bed robot may operate in the caster mode in which separate driving force is not provided such that the moving bed robot moves to a more accurate position.

Referring to FIG. 10 continuously, the controller 90 may determine whether a difference between the detected first external force and the second external force is equal to or greater than a reference value (S110).

When the difference between the first external force and the second external force is less than the reference value (NO of S110), the controller 90 may maintain the currently set movement mode as the movement mode of the moving bed robot (S120).

The controller 90 may maintain the currently set movement mode when the difference between the first external force and the second external force is less than the reference value, thereby preventing traveling instability and user inconvenience due to sudden change in movement mode.

When the difference between the first external force and the second external force is equal to or greater than the reference value (YES of S110) and the first external force is greater than the second external force (YES of S130), the controller 90 may set the movement mode of the moving bed robot to the assist mode (S140).

When the previously set movement mode is the caster mode (or the traveling mode), the controller 90 may switch the movement mode to the assist mode, and, when the previously set movement mode is the assist mode, the controller 90 may maintain the assist mode.

Referring to FIG. 11, a user 1100 may apply external force F1 to the moving bed robot in the front-and-rear direction (e.g., forward).

For example, the user 1100 may apply force (external force F1) to push the moving bed robot forward in a state of gripping the grip hole 11A at the rear side of the moving bed robot. In this case, the external force F1 may be applied to the upper plate 11 of the moving bed robot.

The external force F1 applied to the upper plate 11 may be transmitted to the load cell 19 provided in the moving bed robot. For example, the protrusion portion 13 formed on the bottom of the upper plate 11 may be fastened to the load cell 19 fastened to the lower plate 15. The protrusion portion 13 may apply force to the load cell 19 based on the external force F1 applied to the upper plate 11.

Based on the exemplary structure of FIG. 7, the external force F1 is applied forward, the front protrusion portion 13A and a rear protrusion portion 13B may apply force to the front load cell 19A and the rear load cell 19B forward. In contrast, the left protrusion portion 13C and the right protrusion portion 13D may not apply force to the left load cell 19c and the right load cell 19D in the left-and-right direction.

The load cell (the front load cell 19A and the rear load cell 19B) may be deformed between the protrusion portion 13 and the lower plate 15, and the upper plate 11 may be moved with respect to the lower plate 15 within the deformation range of the load cell 19.

The controller 90 may detect the applied external force F1 based on deformation of the load cell 19. When the external force F1 in the front-and-rear direction is greater than the external force in the left-and-right direction by a reference value or more as a result of detection, the controller 90 may set the movement mode of the moving bed robot to the assist mode.

As the movement mode is set to (switched to or maintained as) the assist mode, the controller 90 may control the driving motors 85A and 85B based on at least one of the first external force or the second external force detected via the load cell 19 (S150).

When the movement mode is set to the assist mode, the controller 90 may control the driving motors 85A and 85B based on at least one of the first external force or the second external force detected via the load cell 19 (C2; see (b) of FIG. 12), thereby assisting movement of the moving bed robot.

For example, when external force having the reference magnitude or more is detected in the first direction in a state in which the moving bed robot travels in the first direction, the controller 90 may control the driving motors 85A and 85B to increase the movement speed in the first direction.

Alternatively, when external force having the reference magnitude or more is detected in the direction opposite to the first direction in a state in which the moving bed robot travels in the first direction, the controller 90 may control the driving motors 85A and 85B to increase the movement speed in the direction opposite to the first direction, that is, decrease the movement speed in the first direction.

Alternatively, when external force having the reference magnitude or more is detected in the second direction perpendicular to the first direction in a state in which the moving bed robot travels in the first direction, the controller 90 may control the driving motors 85A and 85B to maintain (or gradually decrease) the movement speed in the first direction and increase the movement speed in the second direction.

In contrast, when the external force is not detected via the load cell 19 or when the magnitude of the detected external force is less than a reference magnitude, the controller 90 may maintain or gradually decrease the rotation speeds of the driving motors 85A and 85B.

Meanwhile, referring to FIG. 12, when the movement mode is switched from the caster mode to the assist mode, the controller 90 may control the rotary motor 86 (C1) to rotate the moving bracket 83 downward. As seen in (a) of FIG. 12, the driving wheels 84A and 84B connected to the moving bracket 83 may be brought into contact with the floor surface according to rotation of the moving bracket 83.

When a detection signal indicating that the driving wheels 84A and 84B are in contact with the floor surface is received from the contact sensor 89 provided in the driving wheel module 80, the controller 90 may finish driving of the rotary motor 86. Alternatively, the controller 90 may control the rotary motor 86 according to the rotation angle of the moving bracket 83 set with respect to the assist mode.

The controller 90 may control the driving motors 85A and 85B based on the first external force and the second external force detected via the load cell 19, thereby assisting movement in a direction desired by the user.

In contrast, when the difference between the first external force and the second external force is equal to or greater than the reference value (YES of S110) and the first external force is less than the second external force (NO of S130), the controller 90 may set the movement mode of the moving bed robot to the caster mode (S160).

When the previously set mode is the assist mode (or the traveling mode), the controller 90 may switch the movement mode to the caster mode, and, when the previously set mode is the caster mode, the controller 90 may maintain the caster mode.

Referring to FIG. 13, a user 1300 may apply external force F2 to the moving bed robot in the left-and-right direction (e.g., in the left direction).

For example, the user 1300 may apply force (external force F2) pushing the moving bed robot in the left direction at the right side of the moving bed robot. In this case, the external force F2 may be applied to the upper plate 11 of the moving bed robot.

The external force F2 applied to the upper plate 11 may be transmitted to the load cell 19. Based on the exemplary structure of FIG. 7, since the external force F2 is applied in the left direction, the left protrusion portion 13C and the right protrusion portion 13D may apply force to the left load cell 19C and the right load cell 19D in the left direction. In contrast, the front protrusion portion 13A and the rear protrusion portion 13B may not apply force to the front load cell 19A and the rear load cell 19B in the front-and-rear direction.

The load cells (the left load cell 19C and the right load cell 19D) may be deformed between the protrusion portion 13 and the lower plate 15, and the upper plate 11 may be moved with respect to the lower plate 15 within the deformation range of the load cell 19.

The controller 90 may detect the applied external force F2 based on deformation of the load cell 19. When the external force F2 in the left-and-right direction is equal to or greater than the external force in the left-and-right direction by the reference value or more as the result of detection, the controller 90 may set the movement mode of the moving bed robot to the caster mode.

As the movement mode is set to (switched to or maintained as) the caster mode, the controller 90 may deactivate driving of the driving motors 85A and 85B (S170).

As the caster mode is set, the controller 90 may control the driving motors 85A and 85B (C4; see (b) of FIG. 14) to finish (deactivate) driving.

In addition, as shown in (b) of FIG. 14, the controller 90 may control the rotary motor 86 (C3) to rotate the moving bracket 83 upward (see (a) of FIG. 14), thereby releasing contact between the driving wheels 84A and 84B and the floor surface.

As the movement mode is set to the caster mode, the moving bed robot may be moved by the external force applied by the user (or the operator).

Meanwhile, in some embodiments, in order to improve traveling stability of the moving bed robot, steps S130 to S170 may be performed when a state in which the difference between the first external force and the second external force is equal to or greater than the reference value continues for a predetermined time or more.

In some embodiments, the moving bed robot may not have the driving wheel module 80 shown in FIG. 8 and each of the plurality of casters 70 may function as a driving wheel. The controller 90 may control at least one driving motor to provide driving force to the wheel of the caster 70 when the set movement mode is the assist mode. The controller 90 may control at least one driving motor not to provide driving force to the wheel of the caster 70, when the set movement mode is the caster mode.

That is, according to the embodiments shown in FIGS. 10 to 14, the moving bed robot may detect the external force applied to the moving bed robot to provide an appropriate movement mode, thereby effectively assisting the user who applies force to move the moving bed robot.

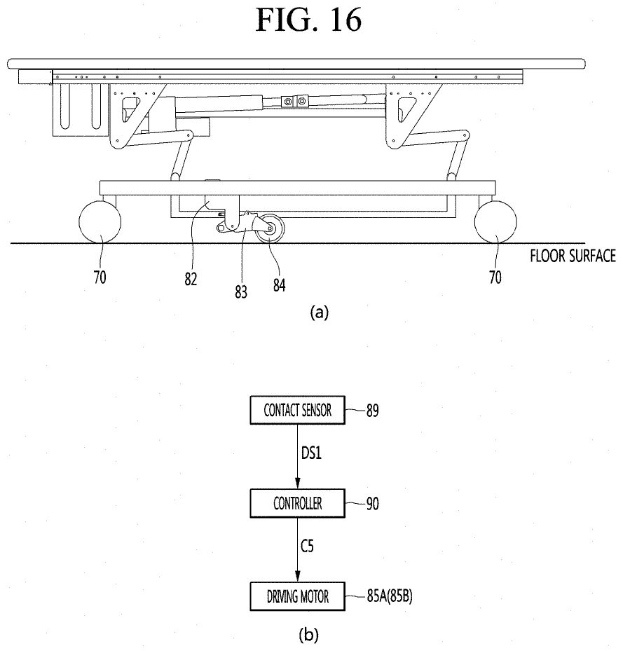

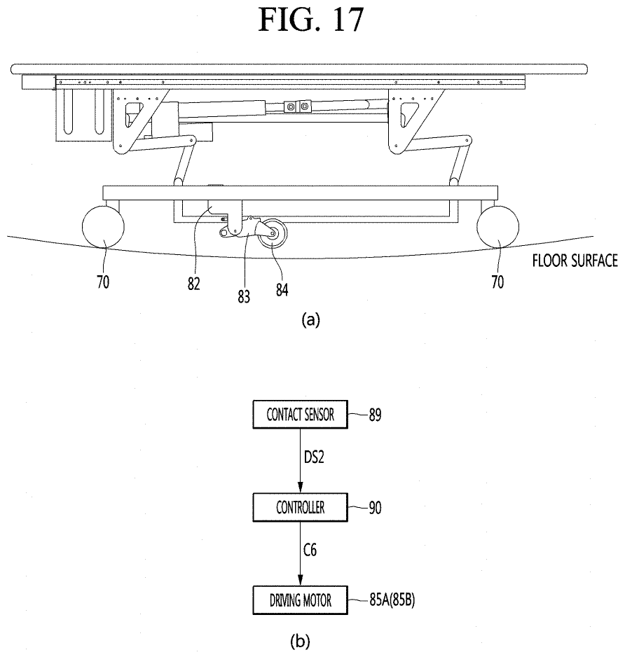

FIG. 15 is a flowchart illustrating movement mode switching operation of a moving bed robot. FIGS. 16 to 17 are views illustrating examples related to operation shown in FIG. 15.

Referring to FIGS. 15 to 17, the controller 90 of the moving bed robot may detect whether the driving wheels 84A and 84B are in contact with the floor surface via the contact sensor 89 (S200).

As described above, the contact sensor 89 may be provided in the driving wheel module 80, without being limited thereto. As described above with reference to FIG. 8, the type of the contact sensor 89 may not be limited and, in some embodiments, the contact sensor 89 may include a proximity sensor for detecting a distance from the floor surface.

When contact or separation between the driving wheels 84A and 84B and the floor surface does not continue for the reference time or more (NO of S210), the controller 90 may maintain the currently set movement mode (S220).

For example, the controller 90 may maintain the currently set movement mode when the result of detection of the contact sensor 89 is frequently changed due to floor surface unevenness, thereby improving traveling stability of the moving bed robot.

When contact between the driving wheels 84A and 84B and the floor surface continues for the reference time or more (YES of S230), the controller 90 may set the movement mode of the moving bed robot to the assist mode (S240).

When the previously set mode is the caster mode (or the traveling mode), the controller 90 may switch the movement mode to the assist mode, and, when the previously set movement mode is the assist mode, the controller 90 may maintain the assist mode.

As the movement mode is set to (switched to or maintained as) the assist mode, the controller 90 may control the driving motors 85A and 85B based on the first external force and the second external force detected via the load cell 19 (S250).

Referring to (a) and (b) of FIG. 16, the controller 90 may receive, from the contact sensor 89, a first detection signal DS1 indicating that the driving wheels 84A and 84B are in contact with the floor surface.

When the first detection signal DS1 is received for a reference time or more, the controller 90 may set the movement mode of the moving bed robot to the assist mode. As the assist mode is set, the controller 90 may control driving of the driving motors 85A and 85B (C5) based on the external force (at least one of the first external force in the front-and-rear direction or the second external force in the left-and-right direction) detected via the load cell 19. The assist mode was described above and a detailed description thereof will be omitted.

In contrast, when separation between the driving wheels 84A and 84B and the floor surface continues for the reference time or more (NO of S230), the controller 90 may set the movement mode of the moving bed robot to the caster mode (S260).

When the previously set movement mode is the assist mode (or the traveling mode), the controller 90 may switch the movement mode to the caster mode, and, when the previously set movement mode is the caster mode, the controller 90 may maintain the caster mode.

As the movement mode is set to (switched to or maintained as) the caster mode, the controller 90 may deactivate driving of the driving motors 85A and 85B (S270).

Referring to (a) and (b) of FIG. 17, for example, when the driving wheels 84A and 84B are separated from the floor surface due to curvature of the floor surface, the contact sensor 89 may transmit a second detection signal DS2 indicating separation from the floor surface to the controller 90.

When the second detection signal DS2 is received for the reference time or more, the controller 90 may set the movement mode of the moving bed robot to the caster mode. As the caster mode is set, the controller 90 may perform control to deactivate driving of the driving motors 85A and 85B (C6).

That is, according to the embodiments shown in FIGS. 15 to 17, the moving bed robot may set the movement mode depending on whether the driving wheels 84A and 84B are in contact with the floor surface. Therefore, since it is possible to prevent unnecessary power consumption due to driving of the driving motors 85A and 85B even if the driving wheels 84A and 84B are not in contact with the floor surface, it is possible to efficiently drive the moving bed robot.

The moving bed robot according to the preferable embodiment of the present disclosure can detect external force applied to the moving bed robot to provide an appropriate movement mode, thereby effectively assisting the user who applies force to move the moving bed robot.

In addition, the moving bed robot may set the movement mode depending on whether the driving wheels are in contact with the floor surface. Therefore, it is possible to prevent unnecessary power consumption due to driving of the driving motor even if the driving wheel is not in contact with the floor surface.

In addition, the moving bed robot may maintain the currently set movement mode under a specific condition, thereby preventing traveling stability from being lowered due to frequent switching of the movement mode.

The foregoing description is merely illustrative of the technical idea of the present disclosure, and various changes and modifications may be made by those skilled in the art without departing from the essential characteristics of the present disclosure.

Therefore, the embodiments disclosed in the present disclosure are to be construed as illustrative and not restrictive, and the scope of the technical idea of the present disclosure is not limited by these embodiments.

The scope of the present disclosure should be construed according to the following claims, and all technical ideas within equivalency range of the appended claims should be construed as being included in the scope of the present disclosure.

What is claimed is:

1. A moving bed robot, comprising:
a plurality of load cells configured to detect external force applied to the moving bed robot in a horizontal direction;
a driving wheel provided on a lower portion of the moving bed robot;
a driving motor configured to rotate the driving wheel;
at least one caster provided on the lower portion of the moving bed robot; and
a controller configured to:
detect, via the plurality of load cells, at least one of a first external force in a first direction and a second external force in a second direction perpendicular to the first direction,
set a movement mode of the moving bed robot based on a result of detecting the at least one of the first external force and the second external force, and
control driving of the driving motor based on the set movement mode.

2. The moving bed robot of claim 1, wherein the moving bed robot is longer in a front-and-rear direction than in a left-and-right direction, and
wherein the first direction corresponds to the front-and-rear direction and the second direction corresponds to the left-and-right direction.

3. The moving bed robot of claim 2, wherein the controller is further configured to, when a difference between the first external force and the second external force is less than a reference value, maintain a currently set movement mode.

4. The moving bed robot of claim 2, wherein the controller is further configured to, when a difference between the first external force and the second external force is greater than or equal to a reference value and the first external force is greater than the second external force:
set the movement mode to an assist mode; and
control driving of the driving motor to vary a rotation speed of the driving wheel based on the first external force.

5. The moving bed robot of claim 4, wherein the controller is further configured to, when the first external force is provided in a same movement direction of the moving bed robot, control driving of the driving motor to increase the rotation speed of the driving wheel, and
wherein the controller is further configured to, when the first external force is provided in a direction opposite the movement direction of the moving bed robot, control driving of the driving motor to decrease the rotation speed of the driving wheel.

6. The moving bed robot of claim 4, further comprising a rotary motor configured to move the driving wheel in a vertical direction,
wherein the controller is further configured to, when the movement mode is set to the assist mode, control the rotary motor such that the driving wheel is moved downward into contact with a floor surface.

7. The moving bed robot of claim 6, further comprising a contact sensor configured to detect whether the driving wheel is in contact with the floor surface,
wherein the controller is further configured to use a result of the detection of the contact sensor to control the rotary motor such that the driving wheel maintains contact with the floor surface.

8. The moving bed robot of claim 2, wherein the controller is further configured to, when a difference between the first external force and the second external force is greater than or equal to a reference value and the second external force is greater than the first external force:
set the movement mode to a caster mode; and
deactivate driving of the driving motor.

9. The moving bed robot of claim 8, further comprising a rotary motor configured to move the driving wheel in a vertical direction,
wherein the controller is further configured to, when the movement mode is set to the caster mode, control the rotary motor such that the driving wheel is moved upward away from contact with a floor surface.

10. The moving bed robot of claim 1, further comprising a contact sensor configured to detect whether the driving wheel is in contact with or separated from a floor surface,
wherein the controller is further configured to set the movement mode based on a result of detection of the contact sensor.

11. The moving bed robot of claim 10, wherein the controller is further configured to, when the contact sensor detects variation of contact and separation between the driving wheel and the floor surface during a period of time less than a reference time, maintain a currently set movement mode.

12. The moving bed robot of claim 10, wherein the controller is further configured to, when the contact sensor detects contact between the driving wheel and the floor surface continuously for a period of time greater than or equal to a reference time:
set the movement mode to an assist mode; and
control driving of the driving motor based on the at least one of the first external force and the second external force detected via the plurality of load cells.

13. The moving bed robot of claim 10, wherein the controller is further configured to, when the contact sensor detects separation between the driving wheel and the floor surface continuously for a period of time greater than or equal to a reference time:
set the movement mode to a caster mode; and
deactivate driving of the driving motor.

14. The moving bed robot of claim 1, further comprising:
an upper plate; and
a frame,
wherein the plurality of load cells is located between the upper plate and the frame to detect movement of the upper plate relative to the frame.

15. A method of controlling a moving bed robot, the method comprising:
detecting, via a plurality of load cells on the moving bed robot, at least one of a first external force applied to the moving bed robot in a first direction and a second external force applied to the moving bed robot in a second direction perpendicular to the first direction;
setting, by a controller of the moving bed robot, a movement mode of the moving bed robot based on a difference between the first external force and the second external force; and
controlling, by the controller of the moving bed robot, a driving motor connected to a driving wheel of the moving bed robot based on the set movement mode.

16. The method of claim 15, wherein the moving bed robot is longer in the first direction than in the second direction,
wherein the setting of the movement mode includes setting the movement mode to an assist mode when the difference between the first external force and the second external force is greater than or equal to a reference value and the first external force is greater than the second external force, and
wherein the controlling of the driving motor includes controlling driving of the driving motor to vary a rotation speed of the driving wheel based on the first external force.

17. The method of claim 16, wherein controlling the driving motor comprises:
controlling driving of the driving motor to increase the rotation speed of the driving wheel when the first external force is provided in a same movement direction of the moving bed robot; and
controlling driving of the driving motor to decrease the rotation speed of the driving wheel when the first external force is provided in a direction opposite the movement direction of the moving bed robot.

18. The method of claim 16, further comprising moving the driving wheel downward to bring the driving wheel into contact with a floor surface when the movement mode is set to the assist mode.

19. The method of claim 15, wherein the setting of the movement mode includes setting the movement mode to a caster mode when the difference between the first external force and the second external force is greater than or equal to a reference value and the second external force is greater than the first external force, and
wherein the controlling of the driving motor includes deactivating driving of the driving motor.

20. The method of claim 19, further comprising moving the driving wheel upward to move the driving wheel away from a floor surface when the movement mode is set to the caster mode.
